(19) United States
(12) Patent Application Publication
(10) Pub. No.: US 2014/0211866 A1
(43) Pub. Date: Jul. 31, 2014

(54) TELECONTROL ENERGY-SAVING APPARATUS FOR SIMULTANEOUS TRANSMISSION OF MULTIPLE SIGNALS WITH POWERLINE TECHNOLOGY

(71) Applicant: Alberto Menghi, Rimini (RN) (IT)

(72) Inventor: Alberto Menghi, Rimini (RN) (IT)

(73) Assignees: Demos FUOCHI, Imola (BO) (IT); Alberto MENGHI, Rimini (RN) (IT)

(21) Appl. No.: 14/237,430

(22) PCT Filed: Aug. 10, 2012
(86) PCT No.: PCT/IT2012/000254

§ 371 Date: Feb. 6, 2014

(30) Foreign Application Priority Data
Aug. 11, 2011 (SM) SM-A-201100038

(51) Int. Cl. H04B 3/54

(52) U.S. Cl. CPC H04B 3/542
USPC 375/257

(57) ABSTRACT

A telecontrol energy-saving apparatus for simultaneous transmission of multiple signals with powerline technology comprises a supervision control unit, and at least one peripheral unit, equipped with an electricity network user device, and with a digital instrument.

### TECHNICAL FIELD

This invention relates to a telecontrol energy-saving apparatus for simultaneous transmission of multiple signals with powerline technology.

### BACKGROUND ART

In telecommunications and electronics, “powerline”, or “PLC” (Power Line Communication) technology has been known and used for some time now, after finding applications, which were initially quite limited, such as controlling electricity distribution systems, reading remote meters, exchange of signals between moving trains and railway stations.

The operating principle of powerline technology is based on superposing, on a low frequency direct or alternating electric current travelling along a metal wire, a higher frequency signal, modulated by the signal of the information to be transmitted.

Interest in said technology is basically due to the fact that, in structures where there are already electricity distribution systems or cable lines for other uses, it allows the creation of new wiring and connections to be avoided. Said wiring and connections would inevitably have involved significant economic costs, as well as an environmental impact that is increasingly difficult to support.

With the massive and multi-form spread, in recent decades, of transmission systems, increasingly widespread in all territories and reaching into homes and places where all types of work, trade and human communication activities take place, powerline technology has also developed.

The constant element which has featured in that development is undoubtedly the gradual increase in powerline system carrier frequency values, and consequently the increase in the possible data transmission speed.

In the current technology, standards have been introduced for powerline systems, which allow transmission speeds of more than 1 Gbit/s, with carrier frequency values able to support any digital data transmission on an electricity network.

Substantially, today powerline systems can operate even in broadband, and therefore they can provide services such as high definition video data flows, to guarantee performance such as the transmission of images in systems for monitoring, security, prevention of events of various types.

Whilst with an increase in frequency and transmission speed the range of powerline system performance has increased, unfortunately there has also been a rise in mutual interference between said systems and other power and transmission systems. Moreover, said mutual interference is also found between powerline electronic apparatuses which, although operating at difference frequency bands, are located close to each other.

The above-mentioned disadvantage precludes the possibility of associating with a narrowband powerline apparatus, a new broadband powerline apparatus. In fact, it is difficult to place them on the same electricity line and/or in the same container device, which may in contrast be necessary due to a lack of alternative positions, or when the presence of the new apparatus must be kept hidden. Amongst the rare cases in which it was possible to place the narrowband and broadband powerline apparatuses on the same electricity line and/or in a single component, in the case in question a streetlight for public lighting, the device which is the subject matter of patent application PCT WO2011/012573 should be mentioned. It relates to a telecontrol system for a plurality of public lighting units, which are associated in their capacity as physical supports for various types of apparatuses, such as video cameras, able to exchange data with the same control unit that manages operation of the lighting unit.

A second type of problem which arises in these apparatuses is that linked to the search for a satisfactory compromise between system efficiency and the energy consumption linked to it. In the prior art, the problem was tackled in two opposite ways.

In the document referred to above, for example, control of the power supplied is located on each peripheral telecontrol unit by means of an electronic inductor. The limits of this solution are obvious: especially on lines made up of a large number of peripheral units, the need for an electronic inductor for each of them means quite high costs. Moreover, in some countries, such as the United States, where mains voltage is only 110V, rather than 220V, the power supplied being equal the doubling of the intensity of the current results in an unsustainable increase in temperatures, seriously harming the lifetime and efficiency of the electronic devices used.

In other solutions, control of the power is located in the central unit to which the electricity lines powering the peripheral units are connected. In this case, regulation controls the supply of power to the electricity lines for operation of the peripheral units, which, in particular, do not necessarily have to operate continuously for the entire day. Therefore, this solution allows consumption to be limited, but, during periods when the peripheral unit is not operating, it also causes apparatuses connected to the same electricity line to correspondingly stop operating.

Therefore, the aim of this invention is to eliminate the above-mentioned disadvantages.

### DISCLOSURE OF THE INVENTION

The invention, with the features described in the claims, achieves the aim by using a centralised power regulator and power supply units, filters and modems, able to operate with variable input voltages and which allow the passage of power and signals in the relevant band, and block interference and overheating between apparatuses.

The main advantage obtained with this invention is basically the fact that a centralised flow regulator combined with switch on and switch off devices which are associated with each user device allows an energy saving of at least 30%.

Moreover, powerline apparatuses can be installed on the same electricity line or in the same container device, despite operating on different frequency bands.

Finally, a new broadband powerline apparatus can be installed in the container device of a pre-existing narrowband powerline apparatus, whose operation remains unchanged.

### BRIEF DESCRIPTION OF THE DRAWINGS

Further advantages and features of the invention are more apparent in the detailed description which follows, with reference to the accompanying drawings, which illustrate a preferred embodiment without limiting the scope of the invention, in which:

FIG. 1 is a block diagram of the invention;

FIG. 2 is a block diagram of a possible alternative embodiment of the invention;

FIG. 3 is a partial block diagram of he invention, with some parts cut away to better illustrate others.

### DETAILED DESCRIPTION OF THE PREFERRED EMBODIMENTS OF THE INVENTION

As can be seen in the accompanying drawings, this invention relates to a telecontrol energy-saving apparatus for simultaneous transmission of multiple signals with dual-band powerline technology,

Said apparatus 100 comprises a supervision control unit 10, and at least one telecontrol peripheral unit 1, able to exchange signals by means of powerline technology.

The supervision control unit 10 is equipped with a voltage regulator 101, designed to modify over time the supply of power to the electricity lines on which the peripheral units 1 are located.

The peripheral unit 1 is provided with at least one electricity network user device 2, such as a streetlight, and connecting means 20 designed to exchange, on narrowband, telecontrol signals between the supervision control unit 10 and the device 2. The device 2 uses narrowband powerline technology power supply means 22, comprising windings 22a with low heat dispersion and high inductive efficiency, therefore with very low induced and conducted emission on the relevant band, in such a way as to avoid causing overheating and interference on the device 2, and above all on the connecting means 20.

The peripheral unit 1 also comprises a digital instrument 3, such as a video camera, and transmission means 30, designed to send, on broadband, signals from the instrument 3 to the supervision control unit 10. Without altering the structure of the peripheral unit 1, the digital instrument 3 could also be, in another example, a radio transmitter apparatus, a loudspeaker, a visual screen for public information, an interactive touch-screen terminal, etc. The instrument 3 uses powerline technology power supply means 32, comprising windings 32a with low heat dispersion and high inductive efficiency, therefore with very low induced and conducted emission on the relevant band, in such a way as to avoid causing overheating and interference on the instrument 3, and above all on the transmission means 30.

Each user device 2 is equipped with a switch on and switch off device 102, in such a way as to allow an energy saving linked to the switching off of the devices 2 or their operation using reduced voltage. However, even in these situations the digital instruments 3 always remain operating and in communication with the supervision control unit 10, guaranteeing, on one hand, an energy saving not lower than 30%, and, on the other hand, constant efficiency of the telecontrol apparatus 100 relative to the digital instruments 3 used in it.

The peripheral unit 1 preferably comprises a single housing component 1a, designed to contain at the same time at least the device 2 and the instrument 3. In a preferred embodiment of the invention, the housing component la also contains the power supply means 22, 32, the connecting means 20 and the transmission means 30, which are connected to the device 2 and to the instrument 3.

The connecting means 20 comprise a narrow band-pass filter 21, designed to prevent interference with the transmission means 30, in such a way that the connecting means 20 correctly dialogue with the supervision control unit 10.

The transmission means 30 comprise a broad band-pass filter 30a, and at least one broadband modem 30b, which are designed to prevent interference with the connecting means 20, in such a way as to correctly dialogue with the supervision control unit 10.

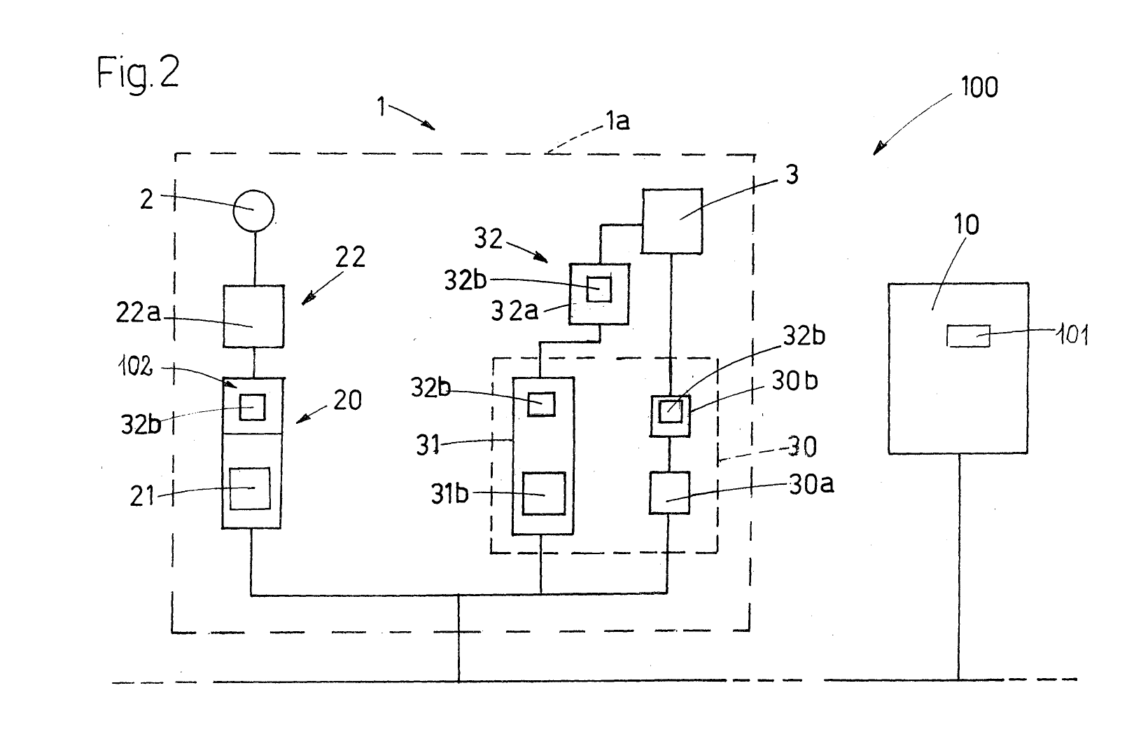

In a possible alternative embodiment of the invention, illustrated in FIG. 2, the transmission means 30 also comprise connecting means 31, provided at least with a narrow band-pass filter 31b, which are designed to exchange signals, such as those relative to on-off commands, on a narrowband powerline system, between the supervision control unit 10 and the instrument 3.

To be certain that the digital instruments 3 keep operating constantly, that is to say, that they are able to exchange data with the supervision control unit 10 at all voltage levels, that is to say, whatever the operating state of the centralised voltage regulator 101, it is appropriate that the transmission means 30, the power supply means 32 and, when present, the connecting means 31 comprise at least one power supply unit 32b with variable input voltage, suitable for operating even at voltage values below 50% of the rated voltage.

A similar strategy should also be used on the devices 2, equipping the connecting means 20 with at least one power supply unit 32b having variable input voltage, suitable for allowing the connecting means 20 to dialogue with the supervision control unit 10 even when the voltage regulator 101 operates with reduced voltage. In this case, the switch on and switch off device 102 is included into the connecting means 20 just by the power supply unit 32b with variable input voltage.

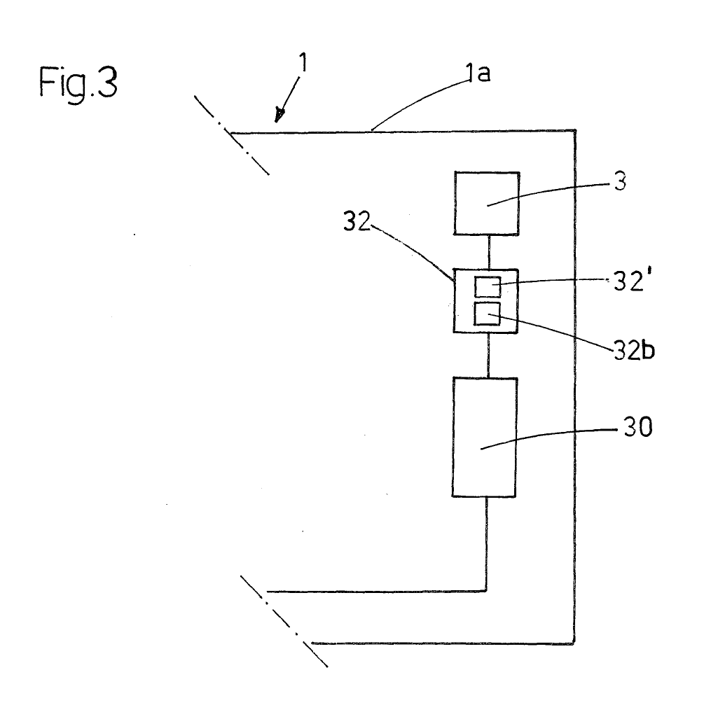

As shown in FIG. 3, the power supply means may be made using a PoE (Power over Ethernet) power supply unit 32, so that it can be used both for transferring data and for supplying electricity, using connections dedicated to the two separate functions.

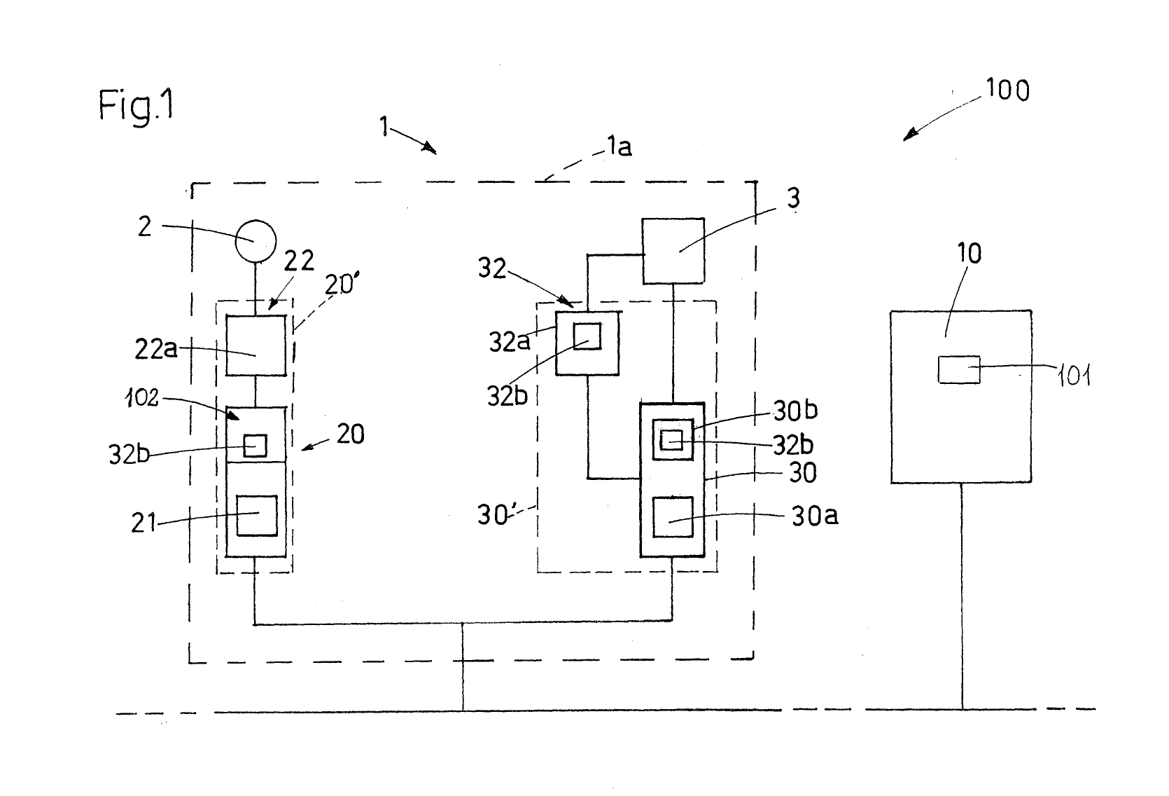

Finally, as shown with a dashed line in FIG. 1, the switch on and switch off device 102 and the power supply means 22 of the device 2 may be assembled in a single structural element 20′. Similarly, the transmission means 30 and the power supply means 32 of the instrument 3 may be assembled in a single structural element

1. A telecontrol energy-saving apparatus for simultaneous transmission of multiple signals with dual-band power line communication technology, comprising a supervision control unit, and at least one telecontrol peripheral unit, the latter being equipped with at least one electricity network user device, power supply means of the device, and connecting means, designed to exchange signals between the supervision control unit and the device, on narrow band, the telecontrol apparatus comprising a digital instrument, power supply means of the instrument, and transmission means, designed to send signals from the instrument to the supervision control unit, on broadband; said telecontrol apparatus being characterised in that it comprises a single voltage regulator located in the supervision control unit and a plurality of switch on and switch off devices for the user devices fixed to them, in such a way as to keep the digital instruments always operating and in communication with the supervision control unit, even when the user devices are off or operating with reduced voltage.

2. The apparatus according to claim 1, characterised in that the peripheral unit comprises a single housing component, designed to contain at least the device and the instrument.

3. The apparatus according to claim 1, characterised in that the connecting means comprise at least one power supply unit having variable input voltage, suitable for allowing the connecting means to dialogue with the supervision control unit even when the voltage regulator operates with reduced voltage.

4. The apparatus according to claim 1, characterised in that the connecting means comprise at least one narrow band-pass filter, designed to prevent interference coming from the transmission means, in such a way that the connecting means dialogue correctly with the supervision control unit.

5. The apparatus according to claim 1, characterised in that the transmission means comprise at least one broad band-pass filter, and at least one broadband, which are designed to prevent interference coming from the connecting means, in such a way as to dialogue correctly with the supervision control unit.

6. The apparatus according to claim 5, characterised in that the transmission means also comprise connecting means, designed to exchange signals between the supervision control unit and the instrument, on narrowband.

7. The apparatus according to claim 5, characterised in that the broadband modem contains at least one power supply unit having variable input voltage, suitable for allowing the transmission means to dialogue with the supervision control unit even when the voltage regulator operates with reduced voltage.

8. The apparatus according to claim 6, characterised in that the connecting means comprise at least one narrow band-pass filter.

9. The apparatus according to claim 6, characterised in that the connecting means comprise at least one power supply unit having variable input voltage, suitable for allowing the transmission means to dialogue with the supervision control unit even when the voltage regulator operates with reduced voltage.

10. The apparatus according to claim 1, characterised in that the power supply means of the device, for narrowband powerline technology, comprise at least one winding with low heat dispersion and high inductive efficiency, in such a way as to avoid causing overheating and interference on the device and on the connecting means.

11. The apparatus according to claim 1, characterised in that the power supply means of the instrument, for broadband powerline technology, comprise at least one winding with low heat dispersion and high inductive efficiency, in such a way as to avoid causing overheating and interference on the instrument and on the transmission means.

12. The apparatus according to claim 1, characterised in that the power supply means of the instrument comprise at least one power supply unit having variable input voltage, suitable for allowing the transmission means to dialogue with the supervision control unit even when the voltage regulator operates with reduced voltage.

13. The apparatus according to claim 1, characterised in that the power supply means comprise a power supply unit using PoE technology.

14. The apparatus according to claim 1, characterised in that it comprises a single structural element, designed to bring together the connecting means and the power supply means of the device.

15. The apparatus according to claim 1, characterised in that it comprises a single structural element, designed to bring together the transmission means and the power supply means of the instrument.
